(19) United States
(12) Patent Application Publication
(10) Pub. No.: US 2022/0039914 A1
(43) Pub. Date: Feb. 10, 2022

(54) Bone Expander

(71) Applicant: Kuan-Lin Wu, Taibao City (TW)

(72) Inventor: Kuan-Lin Wu, Taibao City (TW)

(21) Appl. No.: 16/986,378

(22) Filed: Aug. 6, 2020

(51) Int. Cl. A61C 3/02; A61C 1/08

(52) U.S. Cl. CPC A61C 3/02; A61C 1/08

(57) ABSTRACT

A bone expander contains: a body including a limitation section formed on an upper end of the body, a drill tip formed on a lower end of the body and extending from a bottom of the limitation section, a defining shoulder formed in an expanding umbrella shape and between the bottom of the limitation section and the drill tip, and multiple spiral ribs formed on the drill tip and the limitation section. The drill tip has multiple chip delivery grooves, and a respective chip delivery groove is defined between the drill tip and a respective spiral rib. The limitation section has multiple guide flutes corresponding to the drill tip and extending from the multiple chip delivery grooves, the drill tip has a cutting portion extending from a distal end thereof, and the cutting portion has a conical face formed thereon.

### BACKGROUND OF THE INVENTION

### Field of the Invention

The present invention relates to a bone expander, and more particularly to the bone expander which is capable of reaching a desired drilling length of a maxillary sinus accurately when expanding a bone, wherein when rotating the bone expander clockwise, chips are discharged to cut effectively, and when rotating the bone expander counterclockwise, the chips are filled into multiple chip delivery grooves via the multiple guide flutes, thus repairing the bone.

### Description of the Prior Art

The maxillary sinus is a cavity located in a posterior area of an upper jaw, so the maxillary sinus extends to the posterior area easily to have a shrinking of an alveolar bone day by day. When implanting an artificial tooth to the maxillary sinus, a success rate of an artificial implantation is reduced because of an insufficient height of a bone. However, a sinus lifting is applied to solve the insufficient height of the bone. For example, an instrument is used to lift a mucosa of the maxillary sinus, and bone graft is filled into the bone so as to enhance a height of the bone and to implant the artificial implantation stably.

In a heightening surgery of the maxillary sinus, a dental is hit by an osteotome to crack an alveolar bone on a bottom of the maxillary sinus and to be lifted to a cavity of the maxillary sinus, then artificial bone material is filled into the bottom of the maxillary sinus, thus lifting the mucosa of the maxillary sinus.

Nevertheless, such a hitting vibration will cause psychological pressure on patients. Furthermore, the patients will have dizziness, vomiting, and concussion after a dental implantation. Therefore, the sinus lifting will injures the mucosa of the maxillary sinus to have bleeding, damage of maxillary sinus mucosa, and polyps in the maxillary sinus recorded in clinical literature.

The present invention has arisen to mitigate and/or obviate the afore-described disadvantages.

### SUMMARY OF THE INVENTION

The primary object of the present invention is to provide a bone expander which is capable of overcoming the shortcomings of the conventional bone expander.

To provide above-mentioned objects, a bone expander provided by the present invention contains: a body including a limitation section formed on an upper end of the body, a drill tip formed on a lower end of the body and extending from a bottom of the limitation section, a defining shoulder formed in an expanding umbrella shape and between the bottom of the limitation section and the drill tip, and multiple spiral ribs formed on the drill tip and the limitation section.

The drill tip has multiple chip delivery grooves, and a respective chip delivery groove is defined between the drill tip and a respective spiral rib. The limitation section has multiple guide flutes corresponding to the drill tip and extending from the multiple chip delivery grooves, the drill tip has a cutting portion extending from a distal end thereof, and the cutting portion has a conical face formed thereon.

Accordingly, the bone driller is capable of drilling to a desired length by using a defining shoulder when expanding a bone.

When rotating the body clockwise, the dental implant recess is drilled, and the limitation section has the multiple guide flutes so that chips are discharged via the defining shoulder.

When rotating the body counterclockwise, the cutting portion is moved into a dental implant recess and a maxillary sinus of a bone so that the chips are filled into the multiple chip delivery grooves, thus obtaining a treatment and enhancing a drilling quality.

### BRIEF DESCRIPTION OF THE DRAWINGS

FIG. 1 is a perspective view showing the operation of a part of a bone expander according to a preferred embodiment of the present invention.

FIG. 2 is a perspective view showing the assembly of a part of the bone expander according to the preferred embodiment of the present invention.

FIG. 3 is another perspective view showing the operation of a part of the bone expander according to the preferred embodiment of the present invention.

FIG. 4 is also another perspective view showing the operation of a part of the bone expander according to the preferred embodiment of the present invention.

FIG. 5 is a cross sectional view showing the operation of the bone expander according to the preferred embodiment of the present invention.

FIG. 6 is another cross sectional view showing the operation of the bone expander according to the preferred embodiment of the present invention.

FIG. 7 is also another cross sectional view showing the operation of the bone expander according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

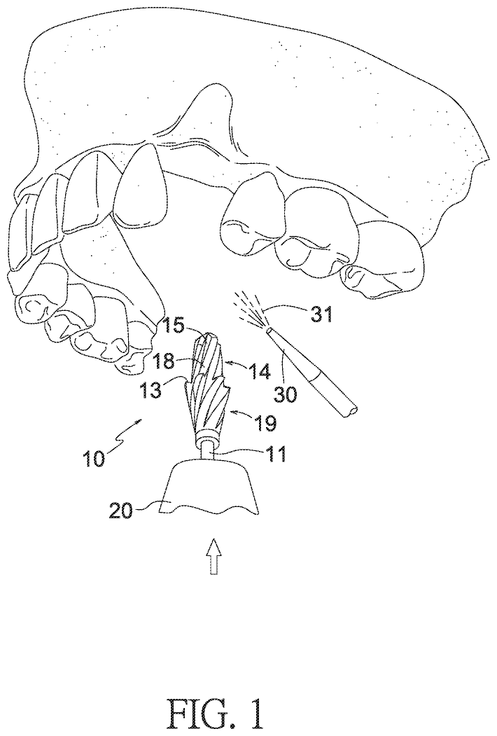

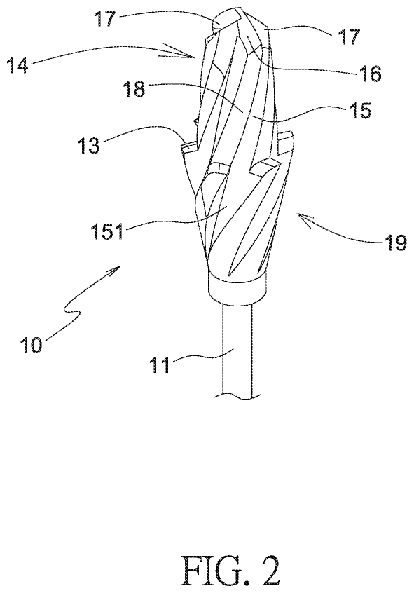

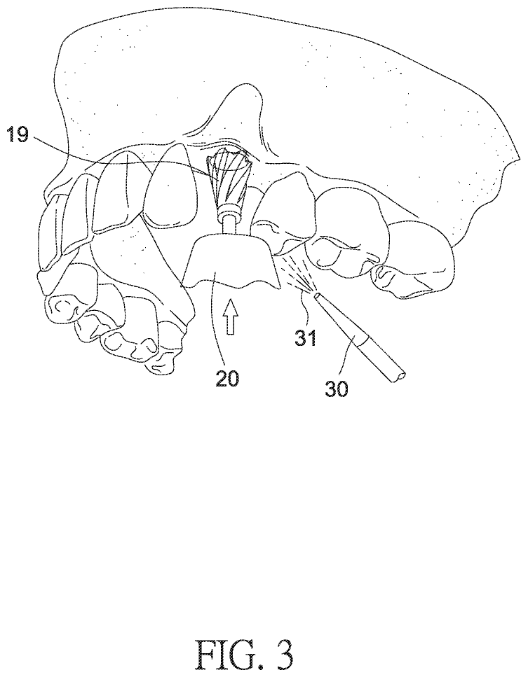

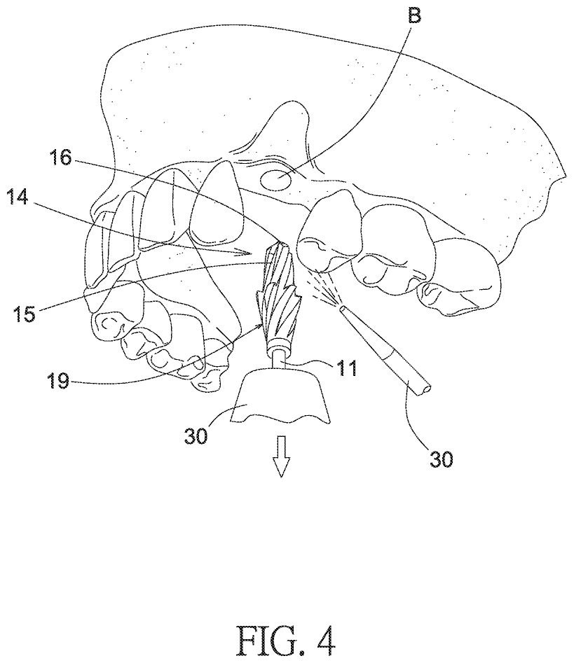

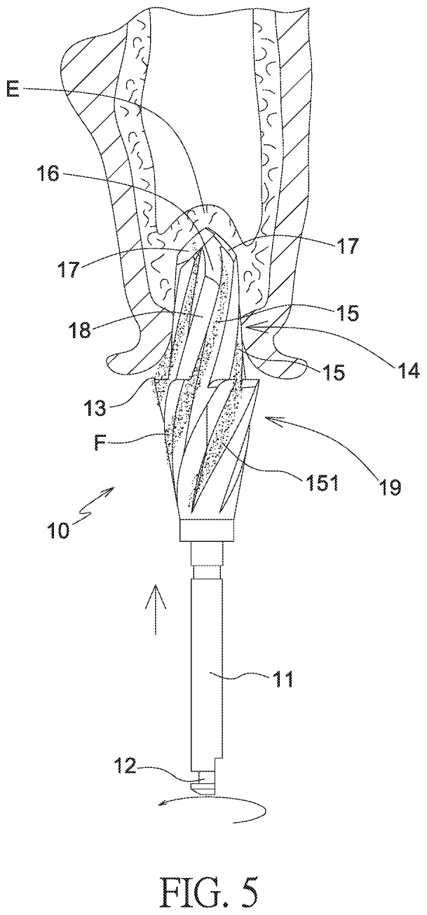

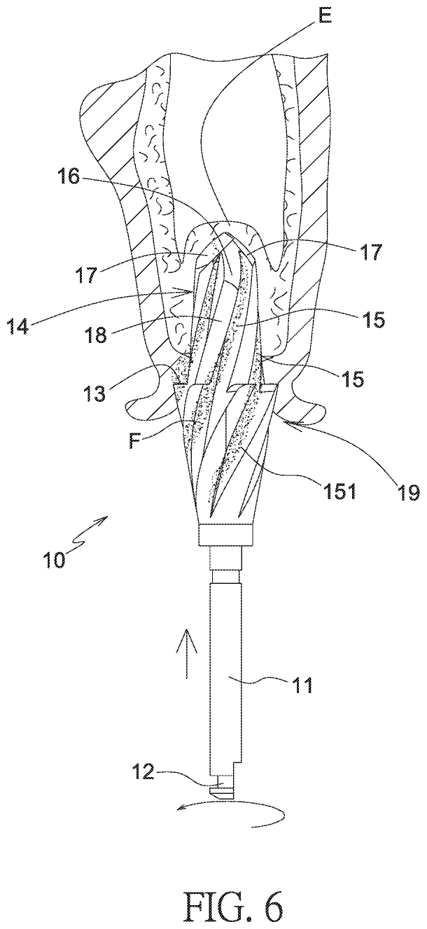

With reference to FIGS. 1-7, a bone expander according to a preferred embodiment of the present invention comprises:

a body 10 including a limitation section 19 formed on an upper end of the body 10, a drill tip 14 formed on a lower end of the body 10 and extending from a bottom of the limitation section 19, a defining shoulder 13 formed in an expanding umbrella shape and between the bottom of the limitation section 19 and the drill tip 14, and multiple spiral ribs 18 formed on the drill tip 14 and the limitation section 19.

The drill tip 14 has multiple chip delivery grooves 15, wherein a respective chip delivery groove 15 is defined between the drill tip 14 and a respective spiral rib 18, and the limitation section 19 has multiple guide flutes 151 corresponding to the drill tip 14 and extending from the multiple chip delivery grooves 15. The drill tip 14 has a cutting portion 16 extending from a distal end thereof, and the cutting portion 16 has a conical face 17 formed thereon.

The body 10 includes a drive shank 11 extending from a top thereof, and the drive shank 11 has an actuation end 12 extending from a top thereof and configured to connect with a driller 20 so that the body 10 rotates in a clockwise direction or a counterclockwise direction successively.

Accordingly, the body 10 includes the limitation section 19 formed in the expanding umbrella shape and includes the drill tip 14 extending from the bottom of the limitation section 19, such that the defining shoulder 13 reaches a desired drilling length of a maxillary sinus accurately.

In operation, the actuation end 12 of the body 10 actuates the driller 20 to rotate clockwise, and chips F are discharged out of the multiple guide flutes 151 of the limitation section 19 via the defining shoulder 13 when drilling the bone.

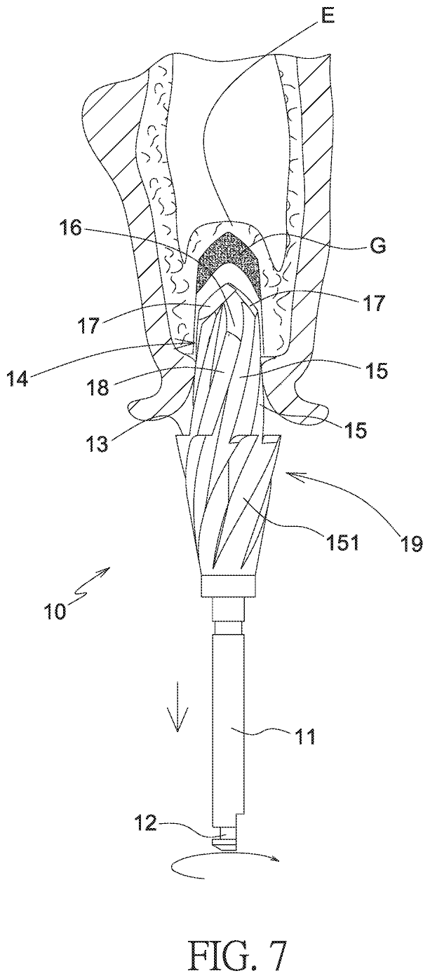

When operating a sinus lifting, the actuation end 12 is connected with the driller 20 and is rotated counterclockwise so that the chips F are filled into the multiple chip delivery grooves 15 via the multiple guide flutes 151, thus increasing a height and a density of the bone, wherein a portion of the bone increased by filling the chips F is a heighten portion G, as shown in FIG. 7, thus securing an artificial implantation and removing the body 10.

Preferably, a dental implant recess B is formed on a predetermined position of a maxillary sinus E so as to generate a bone layer having high density after expanding and pressing the bone layer, thus having a stable implantation.

When operating the bone expander, a water sprayer 30 sprays water 31 to a surgical position so as to facilitate a treatment. Preferably, the body 10 is rotated counterclockwise, and the chips F are delivered inward via the multiple chip delivery grooves 15.

While various embodiments in accordance with the present invention have been shown and described, it is clear to those skilled in the art that further embodiments may be made without departing from the scope of the present invention.

What is claimed is:

1. A bone expander comprising:
a body including a limitation section formed on an upper end of the body, a drill tip formed on a lower end of the body and extending from a bottom of the limitation section, a defining shoulder formed in an expanding umbrella shape and between the bottom of the limitation section and the drill tip, and multiple spiral ribs formed on the drill tip and the limitation section;
wherein the drill tip has multiple chip delivery grooves, and a respective chip delivery groove is defined between the drill tip and a respective spiral rib, wherein the limitation section has multiple guide flutes corresponding to the drill tip and extending from the multiple chip delivery grooves, the drill tip has a cutting portion extending from a distal end thereof, and the cutting portion has a conical face formed thereon.

2. The bone expander as claimed in claim 1, wherein the body includes a drive shank extending from a top thereof, and the drive shank has an actuation end extending from a top thereof and configured to connect with a driller so that the body rotates in a clockwise direction or a counterclockwise direction successively.
